(19) United States
(12) Patent Application Publication
(10) Pub. No.: US 2026/0181227 A1
(43) Pub. Date: Jun. 25, 2026

(54) PASSIVE CAMERA POSTURE MECHANISM OPERATED BY ARM MOVEMENT AND WEARABLE SUIT HAVING THE SAME

(71) Applicant: Samsung Electronics Co., Ltd., Suwon-si (KR)

(72) Inventor: Yongtae KIM, Suwon-si (KR)

(21) Appl. No.: 19/539,880

(22) Filed: Feb. 13, 2026

Related U.S. Application Data
(63) Continuation of application No. PCT/KR2024/011930, filed on Aug. 9, 2024.

(30) Foreign Application Priority Data
Sep. 7, 2023 (KR) 10-2023-0119204

(51) Int. Cl. H04N 23/50; B25J 9/00; F16M 11/10; F16M 11/18; F16M 13/00

(52) U.S. Cl. CPC H04N 23/50; B25J 9/0006; F16M 11/105; F16M 11/18; F16M 13/00

(57) ABSTRACT

A passive camera posture mechanism includes: a camera; a carriage on which the camera is disposed; a vertical guide configured to guide a vertical movement of the carriage; a horizontal carriage on which the vertical guide is disposed; a horizontal guide configured to guide a horizontal movement of the horizontal carriage; a mount configured to be disposed on a shoulder of a user, on which the horizontal guide is disposed; and a connector configured to connect the carriage and the user's arm, such that the carriage and the horizontal carriage move along the vertical guide and the horizontal guide, respectively, according to a movement of the arm.

### CROSS-REFERENCE TO RELATED APPLICATIONS

This application is a continuation of International Application No. PCT/KR 2024/011930 designating the United States, filed on Aug. 9, 2024, in the Korean Ministry of Intellectual Property Receiving Office and claiming priority to Korean Patent Application No. 10-2023-0119204, filed on Sep. 7, 2023, in the Korean Ministry of Intellectual Property, the disclosures of each of which are incorporated by reference herein in their entireties.

### BACKGROUND

### Field

The disclosure relates to a wearable suit, and for example, to a passive camera posture mechanism capable of moving a camera depending on arm movements, and a wearable suit having the same.

### Description of Related Art

Recently, with the advancement of digital technology, various virtual realities are being implemented digitally. For example, virtual reality (VR), augmented reality (AR), mixed reality (MR), extended reality (XR), and the like are being implemented.

In order to implement user interaction in a virtual digital environment, technologies are being developed to recognize the user's body, such as hands and/or arms, and track the body's movements.

For example, technology is being used to track the user's current body position/posture and hand position/posture by recognizing surrounding objects and the user's body using a camera mounted on a head-mounted display (HMD).

Alternatively, technology is being used to track the user's current body position/posture by combining infrared equipment installed outside the user and a tracker attached to the user's body.

### SUMMARY

A passive camera posture mechanism according to an example embodiment of the disclosure may include: a camera; a carriage on which the camera is disposed; a vertical guide configured to guide a vertical movement of the carriage; a horizontal carriage on which the vertical guide is disposed; a horizontal guide configured to guide a horizontal movement of the horizontal carriage; a mounting member comprising a mount configured to be disposed on a shoulder of a user, on which the horizontal guide is disposed; and a connecting member comprising a connector configured to connect the carriage and the user's arm, such that the carriage and the horizontal carriage move along the vertical guide and the horizontal guide, respectively, according to a movement of the arm.

According to an example of the disclosure, the vertical guide may be configured to have a curvature corresponding to a vertical movement trajectory of the arm. According to an example embodiment of the disclosure, the horizontal guide may be configured to have a curvature corresponding to a horizontal movement trajectory of the arm.

According to an example embodiment of the disclosure, the connecting member may be formed of an elastic member comprising a material having elasticity.

According to an example embodiment of the disclosure, the passive camera posture mechanism may further include a return member comprising a spring disposed between an upper end of the vertical guide and the carriage.

According to an example embodiment of the disclosure, the carriage may be disposed at a position where the connecting member and the return member achieve force balance.

According to an example embodiment of the disclosure, the horizontal guide may be arrangeable at a certain distance from a center of a user's shoulder joint.

According to various example embodiments of the disclosure, the camera may include an inertial measurement unit (IMU) comprising circuitry.

According to various example embodiments of the disclosure, the camera may be arrangeable on the carriage so as to capture an image of the user's hand while the user's arm is stretched in a straight line.

According to various example embodiments of the disclosure, a wearable suit may include: a wearable part configured to be worn on a user's torso; and a pair of passive camera posture mechanisms arrangeable on both shoulder portions of the wearable part.

Each of the pair of passive camera posture mechanisms may include: a camera; a carriage on which the camera is disposed; a vertical guide configured to guide a vertical movement of the carriage; a horizontal carriage on which the vertical guide is disposed; a horizontal guide configured to guide a horizontal movement of the horizontal carriage; a mount configured to be disposed on one of both shoulder portions of the wearable part, on which the horizontal guide is disposed; and a connector configured to connect the carriage and the user's arm, such that the carriage and the horizontal carriage move along the vertical guide and the horizontal guide, respectively, according to a movement of the arm.

According to various example embodiments of the disclosure, the wearable part may be configured in a form of an upper garment or an exoskeleton.

### BRIEF DESCRIPTION OF THE DRAWINGS

The above and/or other aspects, features, and advantages of certain embodiments of the present disclosure will be more apparent from the following detailed description taken in conjunction with the accompanying drawings, in which:

FIG. 1 is a perspective view illustrating a passive camera posture mechanism according to various embodiments.

FIG. 2 is a diagram illustrating a front view of the passive camera posture mechanism of FIG. 1 according to various embodiments.

FIG. 3 is a diagram illustrating a plan view of the passive camera posture mechanism of FIG. 1 according to various embodiments.

FIG. 4 is a block diagram illustrating an example configuration of a passive camera posture mechanism according to various embodiments.

FIG. 5 is a diagram illustrating a plan view of a state in which a camera of a passive camera posture mechanism follows a user's hand when the user rotates his or her arm in a horizontal direction according to various embodiments.

FIG. 6 is a diagram illustrating a front view of a state in which a camera of a passive camera posture mechanism captures an image of a user's hand when the user's arm is raised at a 90 degrees according to various embodiments.

FIG. 7 is a diagram illustrating a front view of a state in which a camera of a passive camera posture mechanism captures an image of a user's hand when the user's arm is lowered from the state illustrated in FIG. 6 according to various embodiments.

FIG. 8 is a diagram illustrating a front view of a state in which a camera of a passive camera posture mechanism captures an image of a user's hand when the user's arm is fully lowered according to various embodiments.

FIG. 9 is a diagram illustrating a front view of a state in which a camera of a passive camera posture mechanism captures an image of a user's hand when the user's arm is raised beyond 90 degrees according to various embodiments.

FIG. 10 is a perspective view illustrating a passive camera posture mechanism according to various embodiments.

FIG. 11 is a perspective view illustrating a wearable suit including passive camera posture mechanisms according to various embodiments.

### DETAILED DESCRIPTION

Various embodiments of the disclosure and terms used herein are not intended to limit the technical features described in the disclosure to specific embodiments, but should be understood to include various modifications, equivalents, or alternatives. In connection with the description of the drawings, similar reference numbers may be used for similar or related components.

The singular form of a noun corresponding to an item may include one or more of the above item, unless the relevant context clearly indicates otherwise. In the disclosure, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, the one component can be connected to the another component directly (e.g., wired), wirelessly, or through a third component.

Terms such as “include” or “have” are intended to designate the presence of features, numbers, steps, operations, components, parts, or combinations thereof, but do not preclude the presence or addition of one or more other features, numbers, steps, operations, components, parts, or combination thereof.

When a component is said to be “connected,” “coupled,” “supported,” or “in contact” with another component, this refers not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure relates a passive camera posture mechanism that can expand the range of arm movements that a camera can capture and recognize by mounting the camera that tracks hand and arm movements on a wearable suit and passively moving the camera horizontally and vertically in response to the arm movements.

The disclosure relates to a wearable suit including a passive camera posture mechanism configured to expand the range of camera recognition.

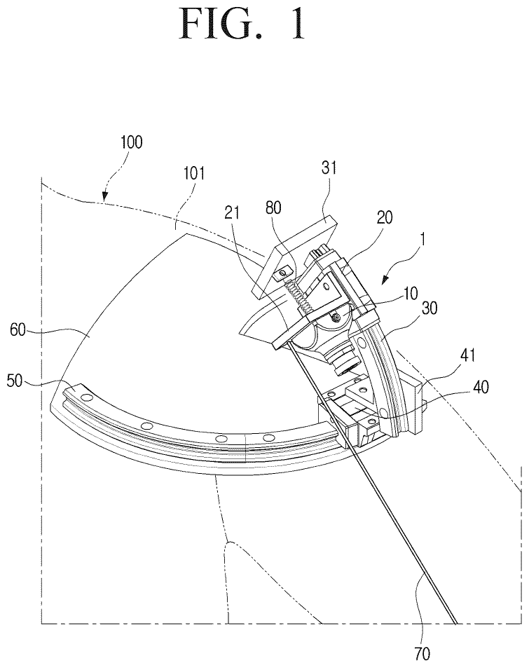

Hereinafter, a passive camera posture mechanism 1 according to various embodiments of the disclosure will be described in greater detail with reference to FIGS. 1 to 4.

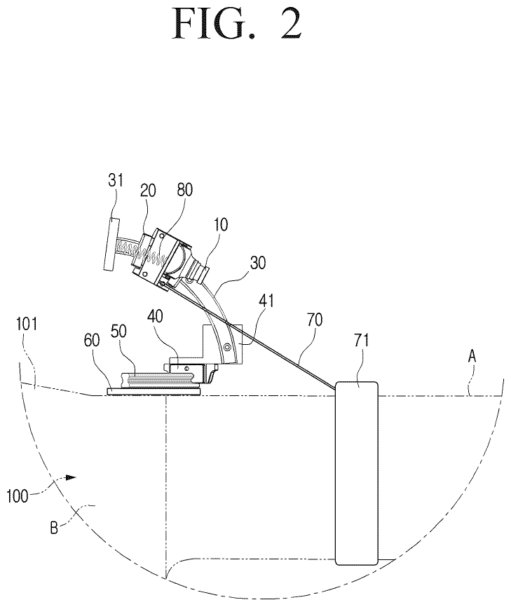

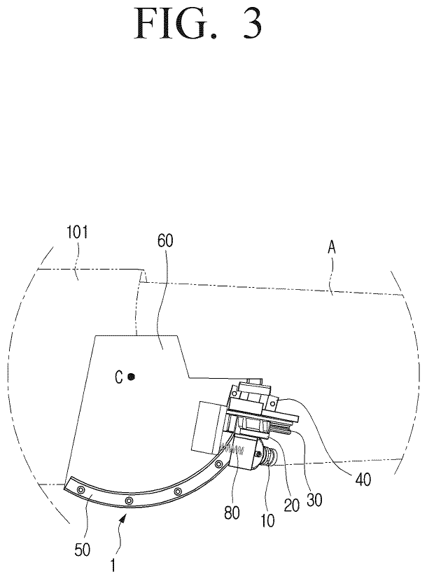

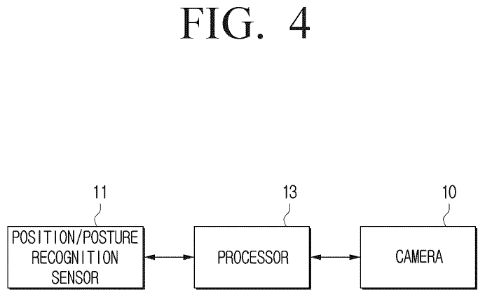

FIG. 1 is a perspective view illustrating a passive camera posture mechanism 1 according to various embodiments. FIG. 2 is a diagram illustrating a front view of the passive camera posture mechanism 1 of FIG. 1 according to various embodiments. FIG. 3 is a diagram illustrating a plan view of the passive camera posture mechanism 1 of FIG. 1 according to various embodiments. FIG. 4 is a block diagram illustrating an example configuration of a passive camera posture mechanism 1 according to various embodiments.

Referring to FIGS. 1 to 4, a passive camera posture mechanism 1 according to one or more embodiments of the disclosure may include a camera 10, a carriage 20, a vertical guide 30, a horizontal carriage 40, a horizontal guide 50, a mounting member 60, and a connecting member 70.

The camera 10 may be configured to capture the movements of the user's hand H and arm A and thereby recognize or track the hand H and arm A. The camera 10 may be any conventional camera capable of capturing, recognizing, or tracking the user's movements. The camera 10 may be a variety of cameras, such as a general digital camera, a depth camera, or a three dimensional (3D) camera. In other words, the camera 10 may be any type of camera, as long as it can capture the movements of the user's hand H and arm A and thereby recognize or track the movements of the hand H and arm A.

The camera 10 may have a certain field of view (FOV). For example, the camera 10 may have various FOVs, such as standard, wide-angle, and ultra-wide-angle FOVs. Using a camera 10 with a large FOV may reduce the distance that the camera 10 moves to track the movements of the hand H and arm A compared to a camera 10 with a small FOV.

The passive camera posture mechanism 1 may include a position/posture recognition sensor 11. The position/posture recognition sensor 11 may be configured to recognize the position and posture of the camera 10. For example, the position/posture recognition sensor 11 may be configured as an inertial measurement unit (IMU) (e.g., including various circuitry). The position/posture recognition sensor 11 may be configured as an encoder.

The position/posture recognition sensor 11 may be configured integrally with the camera 10. For example, the position/posture recognition sensor 11 may be built into the camera 10. As another example, the position/posture recognition sensor 11 may be disposed in the carriage 20 separately from the camera 10. In this case, the position/posture recognition sensor 11 may be disposed adjacent to the camera 10.

The passive camera posture mechanism 1 may include a processor (e.g., including processing circuitry) 13. The processor 13 may be configured to control the camera 10 and the position/posture recognition sensor 11. The processor 13 may be configured to recognize the movements of the hand H and arm A using images of the hand H and arm A captured by the camera 10 and output a corresponding signal. In addition, the processor 13 may be configured to recognize the current position and posture of the camera 10 using a signal transmitted from the position/posture recognition sensor 11, and output the recognized current position and posture of the camera 10.

The processor 13 may be configured integrally with the camera 10. In other words, the processor 13 may be built into the camera 10. As another example, the processor 13 may be disposed separately from the camera 10.

The carriage 20 may be configured to allow the camera 10 to be disposed. In other words, the camera 10 may be fixed to the carriage 20. The camera 10 may be disposed on the carriage 20 to capture images of the user's hand H. In detail, the camera 10 may be disposed on the carriage 20 to capture an image of the user's hand H while the user's arm A is extended straight.

The carriage 20 may include a fixing bracket 21 for fixing the camera 10. In other words, the camera 10 may be fixed to the carriage 20 by the fixing bracket 21.

The carriage 20 may be configured to move along the vertical guide 30. In other words, the carriage 20 may be configured to slide along the vertical guide 30.

The vertical guide 30 may be configured to guide the vertical movement of the carriage 20. Accordingly, the carriage 20 may move up and down along the vertical guide 30. In other words, the carriage 20 may slide up and down along the vertical guide 30.

The vertical guide 30 may be formed in a curved bar shape. The vertical guide 30 may be formed in the shape of a bar bent into an arc shape. The vertical guide 30 may be formed to have a curvature corresponding to the vertical movement trajectory of the arm A. Thus, the carriage 20 may move along a curved trajectory corresponding to the vertical guide 30.

The vertical guide 30 may be configured to have a length corresponding to the vertical rotation angle of the arm A. For example, the vertical guide 30 may be configured to guide the movement of the carriage 20 when the arm A rotates up and down at a 90 degree angle. When the arm A rotates up and down at a 90 degree angle, the carriage 20 may move up and down within a 90 degree range.

The vertical guide 30 may be configured as a curved linear guide. In this case, the carriage 20 may be configured as a block of the curved linear guide. Alternatively, the vertical guide 30 may be configured as a curved rail. However, the shape of the vertical guide 30 may not be limited thereto. The vertical guide 30 may be configured in various shapes as long as they can guide the curved movement of the carriage 20.

The vertical guide 30 may be disposed to move slidely along the horizontal guide 50.

The vertical guide 30 may be disposed on the horizontal carriage 40. For example, the lower end of the vertical guide 30 may be fixed to the horizontal carriage 40. The horizontal carriage 40 may include a support bracket 41 that fixes and supports the vertical guide 30. Then, the vertical guide 30 may move integrally with the horizontal carriage 40. The support bracket 41 may be configured to firmly fix the vertical guide 30 to the horizontal carriage 40. Accordingly, the vertical guide 30 may be fixed to the horizontal carriage 40 so as not to move relative to the horizontal carriage 40.

The horizontal carriage 40 may be disposed to slide along the horizontal guide 50.

The horizontal guide 50 may be disposed to form a substantially perpendicular angle with the vertical guide 30.

The horizontal guide 50 may be configured to guide the horizontal movement of the horizontal carriage 40. Therefore, the horizontal carriage 40 may move in a horizontal direction, e.g., a left-right direction, along the horizontal guide 50. In other words, the horizontal carriage 40 may slide horizontally along the horizontal guide 50. Here, the left-right direction is based on the upper body of the user wearing the passive camera posture mechanism 1.

The horizontal guide 50 may be formed in a curved bar shape. The horizontal guide 50 may be formed in the shape of a bar bent into an arc shape. The horizontal guide 50 may be formed to have a curvature corresponding to the horizontal movement trajectory of the arm A. Then, the horizontal carriage 40 may move along a curved trajectory corresponding to the horizontal guide 50.

The horizontal guide 50 may be formed to have a length corresponding to the horizontal rotation angle of the arm A. For example, the horizontal guide 50 may be configured to guide the movement of the horizontal carriage 40 when the arm A rotates 120 degrees left and right. Then, when the arm A rotates horizontally within a 120-degree angle range, the horizontal carriage 40 may slide along the horizontal guide 50 within a 120-degree range. The horizontal guide 50 may be configured as a curved linear guide. In this case, the horizontal carriage 40 may be configured as a block of the curved linear guide. The horizontal guide 50 may be configured as a curved rail. However, the shape of the horizontal guide 50 may not be limited thereto. The horizontal guide 50 may be formed in various shapes as long as they can guide the curved movement of the horizontal carriage 40.

The horizontal guide 50 and the vertical guide 30 may be configured with the same slide structure or with different slide structures.

The horizontal guide 50 may be disposed on the user's shoulder. The horizontal guide 50 may be disposed on the user's shoulder by the mounting member 60. The horizontal guide 50 may be disposed at a certain distance from the center of the rotation of the arm A.

Here, the center of the rotation of the arm A refers to the shoulder joint connecting the arm A and the torso B. The arm A may rotate up and down and/or left and right within a certain angular range based on the center of rotation.

The mounting member 60 may be configured to secure the horizontal guide 50 and be disposed on the user's shoulder. The mounting member 60 may be disposed on a wearable suit 100. Accordingly, the horizontal guide 50 may be fixed to the wearable suit 100 by the mounting member 60.

For example, the mounting member 60 may be secured to a shoulder portion 101 of the wearable suit 100. The mounting member 60 may be secured to the wearable suit 100 using various securing methods.

The mounting member 60 may support the horizontal guide 50, and the horizontal carriage 40 may be disposed on the horizontal guide 50 so that the horizontal carriage 40 can slide. In addition, the horizontal carriage 40 may move integrally with the vertical guide 30, the carriage 20, and the camera 10. Therefore, the passive camera posture mechanism 1 may be secured to the wearable suit 100 by the mounting member 60.

The connecting member 70 may be configured to move the carriage 20 in accordance with the movement of the arm A. Because the camera 10 is disposed on the carriage 20, when the arm A moves, the camera 10 may follow the arm A and move by the connecting member 70.

The connecting member 70 may be configured to connect the carriage 20 and the user's arm A. One end of the connecting member 70 may be connected to the carriage 20, and the other end thereof may be connected to the user's arm A. Therefore, when the arm A moves, the carriage 20 may move by the connecting member 70.

The connecting member 70 may allow the carriage 20 and the horizontal carriage 40 to move along the vertical guide 30 and the horizontal guide 50, respectively, as the arm A moves.

For example, when the arm A moves up and down, the connecting member 70 may apply a vertical force to the carriage 20, allowing the carriage 20 to move up and down along the vertical guide 30.

When the arm A moves in the horizontal direction, the connecting member 70 may allow the carriage 20 to move in the horizontal direction. In detail, when the arm A moves horizontally, the connecting member 70 may apply a horizontal force to the carriage 20, so that the horizontal force is applied to the vertical guide 30 on which the carriage 20 is disposed. Because the vertical guide 30 is disposed on the horizontal carriage 40, when the horizontal force is applied to the vertical guide 30, the horizontal carriage 40 may move along the horizontal guide 50. Consequently, when the arm A moves horizontally, the carriage 20 on which the camera 10 is disposed may move horizontally by the connecting member 70. In other words, when the arm A moves in the horizontal direction, the camera 10 may move in the horizontal direction according to the movement of the arm A.

The connecting member 70 may be formed of an elastic member. The connecting member 70 may be configured to have elasticity so that the length of the connecting member 70 does not increase when the carriage 20 moves along the vertical guide 30, and so that the length of the connecting member 70 is able to increase to a certain length when the carriage 20 is located at the lower end of the vertical guide 30 and the carriage 20 cannot move. The connecting member 70 may be configured to have elasticity that prevents/suppresses the length of the connecting member 70 from increasing when the horizontal carriage 40 moves along the horizontal guide 50 due to the horizontal force applied to the carriage 20 by the connecting member 70.

One end of the connecting member 70 may be connected to a band 71 worn on the user's arm A. The band 71 may be fixed to any position on the user's arm A. The band 71 may be configured to be worn on or removed from the user's arm A.

The passive camera posture mechanism 1 according to various embodiments of the disclosure may include a return member 80. The return member 80 may be disposed between the upper end of the vertical guide 30 and the carriage 20.

For example, a stopper 31 may be disposed at the upper end of the vertical guide 30. The stopper 31 may be disposed to limit the range of the movement of the carriage 20. In other words, the stopper 31 may be configured to limit the upward movement distance of the carriage 20. One end of the return member 80 may be connected to the stopper 31, and the other end thereof may be connected to the carriage 20.

The return member 80 may be formed of an elastic member. For example, the return member 80 may be formed of a coil spring. The return member 80 may be configured to return the carriage 20, which is located at the lower end of the vertical guide 30, to its original position.

The carriage 20 may be disposed at a position where no force is applied to the return member 80. In this case, the connecting member 70 may be disposed so as not to apply force to the carriage 20. In other words, the carriage 20 may be disposed at a position where the connecting member 70 and the return member 80 achieve a force balance.

Hereinafter, the position on the vertical guide 30 where the carriage 20 does not apply force to the return member 80 is referred to as the original position of the carriage 20.

As an example, when the user's arm A is rotated upward from the attention posture to a 90-degree position, e.g., when the arm A is at a position where it forms approximately 90 degrees with the torso B, the original position of the carriage 20 may be set so that no force is applied to the return member 80 by the carriage 20.

When the arm A is rotated downward in a state where the carriage 20 is in its original position, the connecting member 70 may apply force to the carriage 20, allowing the carriage 20 to move downward along the vertical guide 30. At this time, the return member 80 may be stretched by the force. When the arm A is rotated upward, the carriage 20 may move upward along the vertical guide 30 due to the elastic force of the return member 80. The connecting member 70 may apply an upward force to the carriage 20 to help the carriage 20 move upward along the vertical guide 30.

The return member 80 may be formed of an elastic member having less elasticity than the connecting member 70. Therefore, while the carriage 20 moves from its original position to the lower end of the vertical guide 30, the connecting member 70 may not extend, and the return member 80 may extend. When the arm A moves further downward while the carriage 20 is positioned at the lower end of the vertical guide 30, the connecting member 70 may extend.

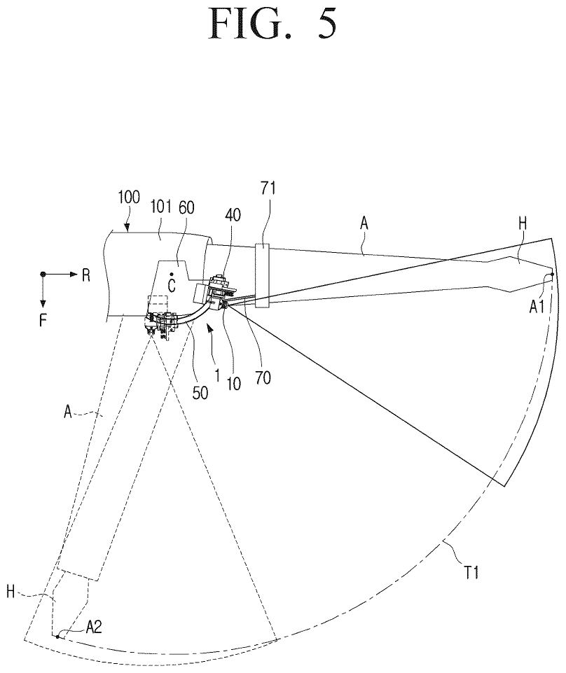

Hereinafter, operation of the passive camera posture mechanism 1 according to various embodiments of the disclosure having the above-described structure will be described in greater detail with reference to FIGS. 5 to 9.

First, a case in which the user raises the arm A approximately 90 degrees from an attention posture and then rotates the arm A horizontally will be described with reference to FIG. 5.

FIG. 5 is a diagram illustrating a plan view of a state in which a camera 10 of a passive camera posture mechanism 1 follows a user's hand H when the user rotates his or her arm A in a horizontal direction according to various embodiments. For reference, in FIG. 5, C represents the center of the shoulder joint connecting the torso B and the arm A. Arrows R and F represent the right and forward directions of the torso B, respectively.

Referring to FIG. 5, the passive camera posture mechanism 1 may be disposed on the user's shoulder, e.g., the shoulder portion 101 of the wearable suit 100 worn by the user. The passive camera posture mechanism 1 may be secured to the shoulder portion 101 of the wearable suit 100 by the mounting member 60.

The horizontal guide 50 of the passive camera posture mechanism 1 disposed on the shoulder portion 101 of the wearable suit 100 may be maintained approximately parallel to the floor. The horizontal guide 50 may be spaced a certain distance from the center C of the shoulder joint. The center of the curvature of the horizontal guide 50 may be located above the center C of the shoulder joint. The vertical guide 30 of the passive camera posture mechanism 1 may be disposed approximately perpendicular to the horizontal guide 50. Therefore, the vertical guide 30 may maintain approximately perpendicular to the floor.

When the user rotates the arm A horizontally at a certain angle, the camera 10 may follow the arm A while the passive camera posture mechanism 1 remains fixed to the shoulder portion 101 of the wearable suit 100. The arm A may move horizontally at a certain angle about the shoulder joint. At this time, the tip of the hand H may form a horizontal movement trajectory T1 of the arm A.

When the user extends his or her arm A to the side, e.g., when the arm A and the torso B are in a straight line (position A1), the horizontal carriage 40 may be positioned at one end of the horizontal guide 50. At this time, the camera 10 disposed in the carriage 20 may capture an image of the user's hand H. In other words, the hand H may be positioned within the field of view of the camera 10 disposed in the carriage 20. Accordingly, the camera 10 may capture and recognize the movements of the arm A and hand H. The processor 13 of the camera 10 may output information about the movements of the arm A and hand H recognized by the camera 10 and the position of the camera 10 measured by the position/posture recognition sensor 11.

In this state, when the user rotates the arm A to the left, the carriage 20 may move to follow the arm A by the connecting member 70 connected to the arm A. Accordingly, the camera 10 disposed on the carriage 20 may move to follow the arm A.

For example, when the arm A is rotated to the left from the position A1, the connecting member 70 connected to the band 71 fixed to the arm A may apply a force horizontally to the carriage 20. Because the carriage 20 is disposed on the vertical guide 30 fixed to the horizontal carriage 40, when the force is applied to the carriage 20, the horizontal carriage 40 may move to the left along the horizontal guide 50. In other words, the carriage 20 may move to the left along the horizontal guide 50. Because the curvature of the horizontal guide 50 is the same as or similar to the curvature of the horizontal movement trajectory T1 of the arm A, when the arm A is rotated in the horizontal direction, the horizontal carriage 40 may move smoothly along the horizontal guide 50. Therefore, the camera 10 disposed on the carriage 20 may follow the user's arm A and move to the left.

When the user's arm A is positioned at position A2, the horizontal carriage 40 may be positioned at the other end of the horizontal guide 50. At this time, the camera 10 disposed on the carriage 20 may also move to follow the user's arm A, so that the camera 10 may capture an image of the user's hand H. In other words, the hand H may be positioned within the field of view of the camera 10 disposed on the carriage 20. Therefore, the camera 10 may capture and recognize the movements of the user's hand H and arm A.

When the user moves the arm A from position A2 to position A1, the carriage 20 may move along the horizontal guide 50 by means of the connecting member 70 disposed between the arm A and the carriage 20.

Because the carriage 20 moves in accordance with the horizontal movement of the arm A, the camera 10 disposed on the carriage 20 may capture and recognize the movements of the arm A and hand H located between positions A1 and A2.

While FIG. 5 illustrates the arm A rotating approximately 120 degrees horizontally, the disclosure is not limited thereto. By extending the length of the horizontal guide 50 or using a camera 10 with a large field of view, the range of horizontal movement of the arm A that the camera 10 is able to recognize may be expanded. In other words, the passive camera posture mechanism 1 according to one or more embodiments of the disclosure may be configured to capture and recognize the movements of the arm A and hand H within the maximum horizontal movement range of the arm A.

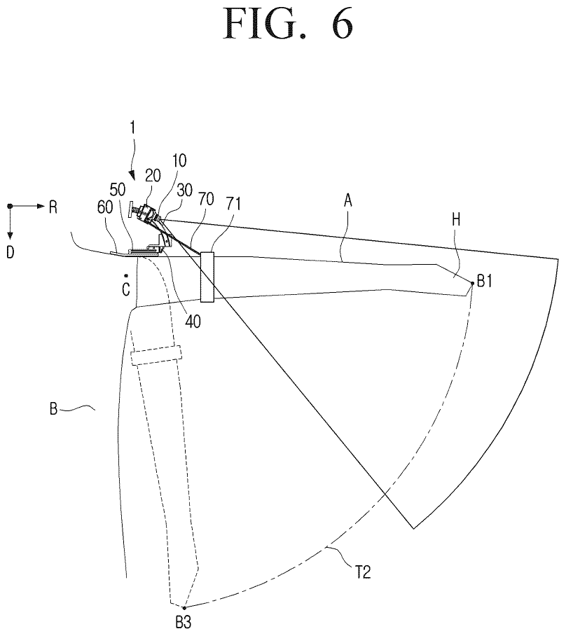

A case where the user rotates the arm A vertically will be described in greater detail below with reference to FIGS. 6 to 9.

FIG. 6 is a diagram illustrating a front view of a state in which a camera 10 of a passive camera posture mechanism 1 captures an image of a user's hand H when the user's arm A is raised at a 90-degree angle according to various embodiments. For reference, in FIG. 6, C represents the center of the shoulder joint connecting the torso B and the arm A. Arrows R and D represent the rightward and downward directions of the torso B, respectively.

Referring to FIG. 6, the passive camera posture mechanism 1 according to one or more embodiments of the disclosure may be disposed on the user's shoulder, e.g., the shoulder portion 101 of the wearable suit 100 worn by the user. The passive camera posture mechanism 1 may be secured to the shoulder portion 101 of the wearable suit 100 by the mounting member 60.

The vertical guide 30 of the passive camera posture mechanism 1 disposed on the shoulder portion 101 of the wearable suit 100 may be maintained in a state approximately perpendicular to the floor. In addition, the vertical guide 30 may be spaced a certain distance upward from the center C of the shoulder joint. The center of the curvature of the vertical guide 30 may be located above the center C of the shoulder joint. The horizontal guide 50, which supports and guides the horizontal movement of the vertical guide 30, may be maintained in a state approximately parallel to the floor.

When the user rotates the arm A up and down at a certain angle, the camera 10 may follow the arm A while the passive camera posture mechanism 1 remains fixed to the shoulder portion 101 of the wearable suit 100. The arm A may move vertically at a certain angle about the shoulder joint. At this time, the tip of the hand H may form a vertical movement trajectory T2 of the arm A.

When the user extends his or her arm A to the side, e.g., when the arm A and the torso B are in a straight line (position B1), the carriage 20 may be positioned at the original position on the vertical guide 30. For example, the carriage 20 may be positioned at a position where no force is applied to the carriage 20 by the return member 80 and the connecting member 70. The camera 10 disposed in the carriage 20 may capture an image of the user's hand H. For example, the hand H may be located within the field of view of the camera 10 disposed in the carriage 20. Accordingly, the camera 10 may capture and recognize the movements of the user's arm A and hand H. Then, the processor 13 of the camera 10 may output information about the movements of the arm A and hand H recognized by the camera 10 and the position of the camera 10 measured by the position/posture recognition sensor 11.

In this state, when the user rotates the arm A downward, the carriage 20 may move downward following the arm A by the connecting member 70 connected to the arm A.

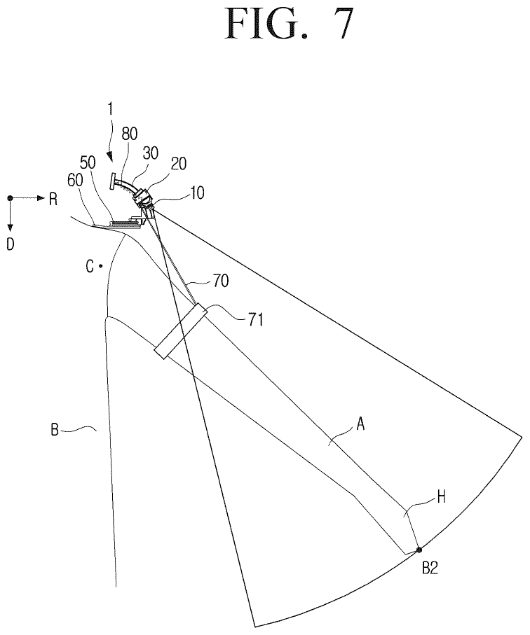

Accordingly, the camera 10 disposed on the carriage 20 may move downward following the arm A. The state in which the arm A rotates downward at a certain angle is illustrated in FIG. 7.

FIG. 7 is a diagram illustrating a front view of a state in which a camera 10 of a passive camera posture mechanism 1 captures an image of a user's hand H when the user's arm is lowered in the state illustrated in FIG. 6 according to various embodiments. For reference, in FIG. 7, C represents the center of the shoulder joint connecting the torso B and the arm A. Arrows R and D represent the rightward and downward directions of the torso B, respectively.

Referring to FIG. 7, when the arm A is rotated downward from position B1 and is moved to position B2, the connecting member 70 connected to the band 71 fixed to the arm A may apply a downward force to the carriage 20. Because the carriage 20 is slidably disposed on the vertical guide 30, when the downward force is applied to the carriage 20, the carriage 20 may move downward along the vertical guide 30. Because the curvature of the vertical guide 30 is the same as or similar to the curvature of the vertical movement trajectory of the arm A, when the arm A rotates downward, the carriage 20 may move smoothly along the vertical guide 30. Therefore, the camera 10 disposed on the carriage 20 may follow the user's arm A and move downward.

When the user's arm A is positioned at position B2, the carriage 20 may move downward a certain distance along the vertical guide 30. At this time, the camera 10 disposed on the carriage 20 may move following the user's arm A, so that the camera 10 may capture an image of the user's hand H. In other words, the hand H may be positioned within the field of view of the camera 10 disposed on the carriage 20. Therefore, the camera 10 may capture and recognize the movements of the user's arm A and hand H.

In addition, when the user's arm A is positioned at position B2, the return member 80 may be extended as much as the carriage 20 has moved downward along the vertical guide 30. In this state, when the user further rotates the arm A downward, the carriage 20 may move downward along the vertical guide 30 by the connecting member 70 connected to the arm A. Accordingly, the camera 10 disposed on the carriage 20 may move downward further

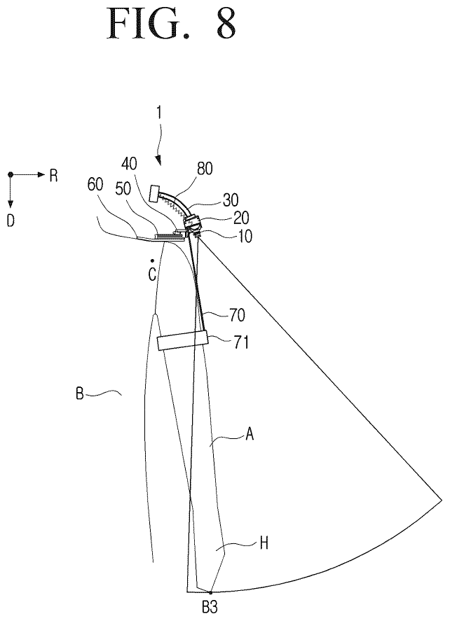

following the arm A. The state in which the arm A has rotated downward to its maximum is illustrated in FIG. 8. FIG. 8 is a diagram illustrating a front view of a state in which a camera 10 of a passive camera posture mechanism 1 captures an image of a user's hand H when the user's arm A is fully lowered according to various embodiments. For reference, in FIG. 8, C represents the center of the shoulder joint connecting the torso B and the arm A. Arrows R and D represent the right and downward directions of the torso B, respectively.

Referring to FIG. 8, when the arm A is further rotated downward from position B2, the connecting member 70 connected to the band 71 fixed to the arm A may apply a downward force to the carriage 20. Because the carriage 20 is slidably disposed on the vertical guide 30, when the downward force is applied to the carriage 20, the carriage 20 may move downward along the vertical guide 30.

When the user's arm A is rotated downward to the maximum and positioned at position B3, the carriage 20 may be positioned at the lower end of the vertical guide 30. The camera 10 disposed on the carriage 20 may move following the user's arm A, so that the camera 10 may capture an image of the user's hand H. For example, the hand H may be positioned within the field of view of the camera 10 disposed on the carriage 20. Therefore, the camera 10 may capture and recognize the movements of the user's arm A and hand H.

When the carriage 20 is positioned at the lower end of the vertical guide 30 and the user's arm A is not in contact with the torso B, the connecting member 70 may extend, allowing the user to bring the arm A into contact with the torso B. In this case, the camera 10 may be configured to have the field of view capable of capturing images of the arm A and hand H in contact with the torso B.

When the user's arm A is positioned at position B3, the return member 80 may be extended as much as the carriage 20 has moved downward along the vertical guide 30. At this time, the return member 80 may be extended further than at position B2.

The user may rotate the arm A upward from the position B3.

When the arm A is rotated upward from position B3, the carriage 20 may move upward due to the elasticity of the return member 80 disposed between the upper end of the vertical guide 30 and the carriage 20. Because the carriage 20 is slidably disposed on the vertical guide 30, when the return member 80 pulls the carriage 20 upward, the carriage 20 may move upward along the vertical guide 30. Accordingly, the camera 10 disposed on the carriage 20 may move upward following the user's arm A, so that the camera 10 may capture and recognize the movements of the arm A and hand H.

When the arm A is rotated upward from position B3, the connecting member 70 connected to the band 71 fixed to the arm A may push the carriage 20 upward. This may allow the carriage 20 to move upward more easily along the vertical guide 30.

When the user's arm A rises to position B1 in FIG. 6, the carriage 20 may be positioned in the original position.

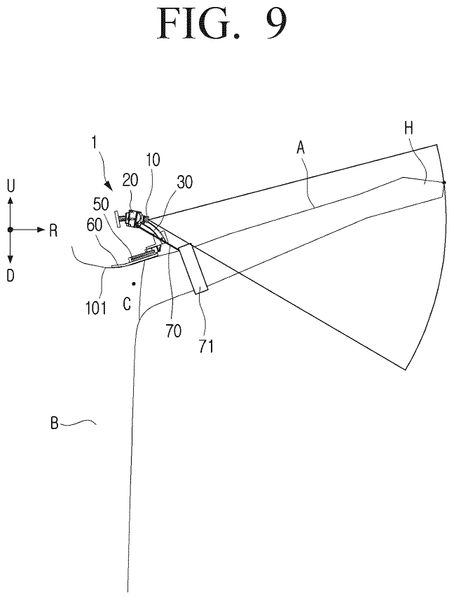

In the state of FIG. 6, when the user further raises the arm A, the camera 10 may follow the hand H. This state is illustrated in FIG. 9.

FIG. 9 is a diagram illustrating a front view of a state in which a camera 10 of a passive camera posture mechanism 1 captures an image of a user's hand H when the user's arm A is raised beyond 90 degrees according to various embodiments. For reference, in FIG. 9, C represents the center of the shoulder joint connecting the torso B and the arm A. Arrows R, U, and D represent the right, upward, and downward directions of the torso B, respectively.

When the user rotates the arm A upward by more than 90 degrees, not only the arm A is rotated upward, but also the shoulder is raised upward. Accordingly, as illustrated in FIG. 9, the passive camera posture mechanism 1 according to one or more embodiments of the disclosure disposed on the shoulder portion 101 of the wearable suit 100 worn by the user may be raised together with the user's shoulder. For example, when the arm A is raised upward by 90 degrees or more, not only the carriage 20 may move upward along the vertical guide 30, but also the passive camera posture mechanism 1 on which the camera 10 is disposed may be raised upward as a whole.

Therefore, because the camera 10 of the passive camera posture mechanism 1 is raised along with the shoulder, the camera 10 may capture and recognize the user's arm A and hand H.

Accordingly, according to the passive camera posture mechanism 1 according to one or more embodiments of the disclosure, the camera 10 may track the arm A and hand H when the arm A is raised by more than 90 degrees from the attention posture.

In the above, it has been described that the camera 10 of the passive camera posture mechanism 1 according to one or more embodiments of the disclosure follows the arm A and hand H when the arm A is raised at about 90 degrees and rotated horizontally, and when the arm A is extended so as to be in a straight line with the torso B and is rotated vertically.

However, the disclosure is not limited thereto. The passive camera posture mechanism 1 according to one or more embodiments of the disclosure may capture and recognize the movements of the arm A and hand H positioned at any angle within the maximum motion range of the arm A that can rotate the arm A up and down and left and right.

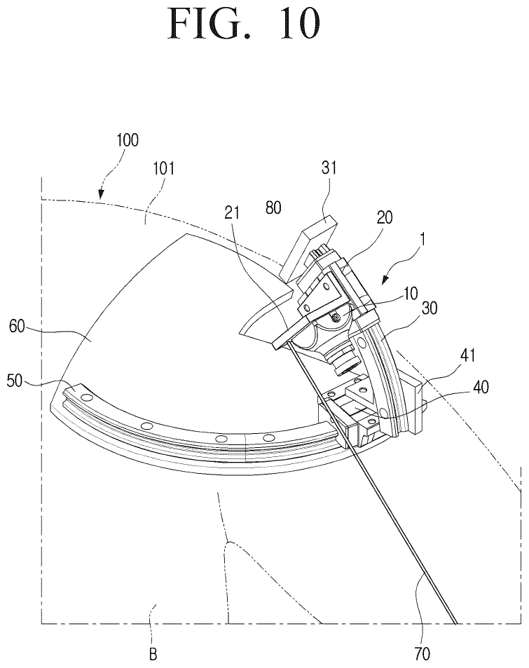

FIG. 10 is a perspective view illustrating a passive camera posture mechanism 1 according to various embodiments of the disclosure.

Referring to FIG. 10, a passive camera posture mechanism 1 according to one or more embodiments of the disclosure may include a camera 10, a carriage 20, a vertical guide 30, a horizontal carriage 40, a horizontal guide 50, a mounting member 60, and a connecting member 70.

The camera 10, carriage 20, vertical guide 30, horizontal carriage 40, horizontal guide 50, and mounting member 60 of the passive camera posture mechanism 1 according to one or more embodiments of the disclosure may be identical or similar to those of the passive camera posture mechanism 1 according to the aforementioned embodiment, and therefore, detailed descriptions thereof may not be repeated here.

The connecting member 70 of the passive camera posture mechanism 1 according to this embodiment may be different from the connecting member 70 of the passive camera posture mechanism 1 according to the various embodiments.

The connecting member 70 may be formed of a rigid material. In other words, the connecting member 70 may be formed of a material that does not stretch when a force is applied thereto. When the connecting member 70 is formed of a rigid material, the vertical rotation angle of the arm A that the passive camera posture mechanism 1 is able to follow may be reduced.

As illustrated in FIG. 5, when the arm A is rotated horizontally, the connecting member 70 connected to the arm A may apply a horizontal force to the carriage 20. When the horizontal force is applied to the carriage 20, the vertical guide 30 on which the carriage 20 is disposed may move horizontally along the horizontal guide 50 together with the horizontal carriage 40. Accordingly, the camera 10 disposed on the carriage 20 may move to follow the arm A, so that the camera 10 may capture and recognize the movements of the arm A and hand H.

Because the connecting member 70 of the passive camera posture mechanism 1 according to this embodiment is not deformed by the movement of the arm A, the connecting member 70 may push the carriage 20 upward when the arm A is rotated upward. This may allow the carriage 20 to move upward along the vertical guide 30. Therefore, when the arm A is rotated upward, the camera 10 disposed on the carriage 20 may capture and recognize the movements of the arm A and hand H.

Accordingly, the passive camera posture mechanism 1 according to this example may not include a return member 80.

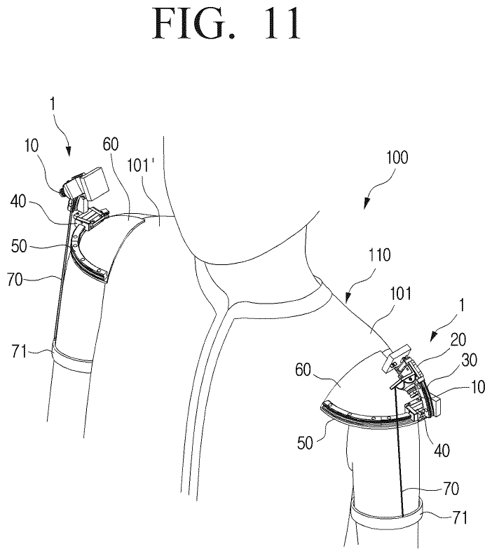

Hereinafter, a wearable suit 100 equipped with passive camera posture mechanisms 1 according to various embodiments will be described in greater detail with reference to FIG. 11.

FIG. 11 is a perspective view illustrating a wearable suit 100 including a passive camera posture mechanism 1 according to various embodiments.

Referring to FIG. 11, a wearable suit 100 according to various embodiments may include a wearable part 110 and a pair of passive camera posture mechanisms 1.

The wearable part 110 may be configured to be worn on the user's torso B. The wearable part 110 may be configured in the form of a general clothing upper garment. The wearable part 110 may be formed from various materials, such as fabric, leather, etc. The wearable part 110 may be configured to be worn on the torso B in various ways, such as a T-shirt, shirt, zipper, etc.

As another example, the wearable part 110 may be configured in the form of an exoskeleton.

The wearable part 110 may include a pair of mount seats. The pair of mount seats may be provided on both shoulder portions 101 and 101′ of the wearable part 110. The mount seats may be configured to secure the mounting member 60 of the passive camera posture mechanism 1. Accordingly, by securing the mounting member 60 of the above-described passive camera posture mechanism 1 to the mount seat of the wearable part 110, the passive camera posture mechanism 1 may be secured to the wearable part 110.

As another example, the wearable part 110 may be configured such that the mounting member 60 of the passive camera posture mechanism 1 is directly disposed on the shoulder portions 101 and 101′ of the wearable suit 100, without providing the mount seats on the shoulder portions 101 and 101′ of the wearable suit 100.

The pair of passive camera posture mechanisms 1 may be disposed on both shoulder portions 101 and 101′ of the wearable part 110. The pair of passive camera posture mechanisms 1 may be configured to capture and recognize the movements of both arms A and both hands H.

For example, the passive camera posture mechanism 1 disposed on the right shoulder portion 101 of the wearable part 110 may be configured to capture and recognize the movements of the right arm A and right hand H. The passive camera posture mechanism 1 disposed on the left shoulder portion 101′ of the wearable part 110 may be configured to capture and recognize the movements of the left arm and left hand.

Therefore, when the user wears the wearable suit 100 according to one or more embodiments of the disclosure, the pair of passive camera posture mechanisms 1 may capture and recognize the movements of both arms A and both hands H, and output information related thereto.

The structure and operation of the pair of passive camera posture mechanisms 1 are substantially the same as those of the above-described passive camera posture mechanism 1, and therefore, a detailed description thereof may not be repeated here.

The passive camera posture mechanism 1 according to various embodiments having the above-described structure may allow the camera 10 to passively move in accordance with the movement of the arm A and follow the arm A, thereby capturing and recognizing the movements of the arm A and hand H.

The passive camera posture mechanism 1 according to various embodiments may be configured so that the camera 10 passively moves horizontally and vertically in accordance with the movement of the arm A, thereby expanding the range of motion of the arm A that the camera 10 can recognize.

The wearable suit 100 according to various embodiments may recognize the movements of both arms A and both hands H while worn on the user's upper body, thereby resolving issues with commercially available head-mounted displays. For example, it may prevent/reduce musculoskeletal diseases, skin diseases, and other diseases that may be caused by head-mounted displays.

Performing fitness contents while wearing a head-mounted display may have limitations due to heat and stuffiness. However, the wearable suit 100 according to one or more embodiments of the disclosure may not suffer from these issues. Therefore, the wearable suit 100 according to various embodiments may be useful for utilizing fitness contents.

Because the camera 10 of a head-mounted display does not move, the range of recognition of the movements of the arm A and hand H may be very narrow. However, the passive camera posture mechanism 1 according to various embodiments may have a very wide range of recognition of the movements of the arm A and hand H because the camera 10 moves up, down, left, and right according to the movements of the arm A.

The passive camera posture mechanism 1 according to various embodiments may have low maintenance costs because the camera 10 moves in conjunction with the movements of the user's arm A without using a driving device such as a motor.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A passive camera posture mechanism comprising:
a camera;
a carriage on which the camera is disposed;
a vertical guide configured to guide a vertical movement of the carriage;
a horizontal carriage on which the vertical guide is disposed;
a horizontal guide configured to guide a horizontal movement of the horizontal carriage;
a mounting member including a mount configured to be disposed on a shoulder of a user, on which the horizontal guide is disposed; and
a connecting member comprising a connector configured to connect the carriage and the user's arm, such that the carriage and the horizontal carriage move along the vertical guide and the horizontal guide, respectively, according to a movement of the arm.

2. The passive camera posture mechanism of claim 1, wherein the vertical guide is configured to have a curvature corresponding to a vertical movement trajectory of the arm.

3. The passive camera posture mechanism of claim 1, wherein the horizontal guide is configured to have a curvature corresponding to a horizontal movement trajectory of the arm.

4. The passive camera posture mechanism of claim 1, wherein the connecting member includes an elastic member comprising an elastic material.

5. The passive camera posture mechanism of claim 4, further comprising:
a return member comprising a spring disposed between an upper end of the vertical guide and the carriage.

6. The passive camera posture mechanism of claim 5, wherein
the carriage is disposed at a position where the connecting member and the return member achieve force balance.

7. The passive camera posture mechanism of claim 1, wherein
the horizontal guide is configured to be arranged at a certain distance from a center of a user's shoulder joint.

8. The passive camera posture mechanism of claim 1, wherein
the camera includes an inertial measurement unit (IMU) comprising a sensor.

9. The passive camera posture mechanism of claim 1, wherein
the camera is arrangeable on the carriage to capture an image of the user's hand while the user's arm is stretched in a straight line.

10. A wearable suit comprising:
a wearable part configured to be worn on a user's torso; and
a pair of passive camera posture mechanisms arrangeable on both shoulder portions of the wearable part, each of the pair of passive camera posture mechanisms comprising:
a camera;
a carriage on which the camera is disposed;
a vertical guide configured to guide a vertical movement of the carriage;
a horizontal carriage on which the vertical guide is disposed;
a horizontal guide configured to guide a horizontal movement of the horizontal carriage;
a mounting member comprising a mount configured to be disposed on one of both shoulder portions of the wearable part, on which the horizontal guide is disposed; and
a connecting member comprising a connector configured to connect the carriage and the user's arm, such that the carriage and the horizontal carriage move along the vertical guide and the horizontal guide, respectively, according to a movement of the arm.

11. The wearable suit of claim 10, wherein
the vertical guide is configured to have a curvature corresponding to a vertical movement trajectory of the arm.

12. The wearable suit of claim 10, wherein
the horizontal guide is configured to have a curvature corresponding to a horizontal movement trajectory of the arm.

13. The wearable suit of claim 10, further comprising:
a return member comprising a spring disposed between an upper end of the vertical guide and the carriage.

14. The wearable suit of claim 13, wherein
the carriage is disposed at a position where the connecting member and the return member achieve force balance.

15. The wearable suit of claim 10, wherein
the wearable part is configured in a form of an upper garment and/or an exoskeleton.
